(19) United States
(12) Patent Application Publication
(10) Pub. No.: US 2025/0210228 A1
(43) Pub. Date: Jun. 26, 2025

(54) ANTI-SHRINK BACK DEVICE

(71) Applicant: SHOALS TECHNOLOGIES GROUP, LLC, Portland, TN (US)

(72) Inventors: Troy W. Renken, Portland, TN (US); David L. Schardt, Portland, TN (US)

(21) Appl. No.: 18/957,090

(22) Filed: Nov. 22, 2024

Related U.S. Application Data
(60) Provisional application No. 63/612,951, filed on Dec. 20, 2023.

(51) Int. Cl. H01B 7/40

(52) U.S. Cl. CPC H01B 7/40

(57) ABSTRACT

In an example, an anti-shrink back device is positionable at least partially around insulation of an electrical conductor at an end of the insulation adjacent to an uninsulated segment of the electrical conductor. The anti-shrink back device includes a band mechanically tightenable at least partially around the insulation at the end of the insulation adjacent to the uninsulated segment to secure or inhibit movement of the end of the insulation longitudinally relative to the electrical conductor.

### CROSS-REFERENCE TO RELATED APPLICATION

This application is related to U.S. Provisional App. No. 63/612,951 filed Dec. 20, 2023 and titled ANTI-SHRINK BACK COLLAR.

### FIELD

Embodiments described herein relate to an anti-shrink back device.

### BACKGROUND

Unless otherwise indicated in the present disclosure, the materials described in the present disclosure are not prior art to the claims in the present application and are not admitted to be prior art by inclusion in this section.

Insulated wire used in photovoltaic (PV) applications is subjected to wide ambient temperature ranges which can result in the wire insulation experiencing “shrink back” to a degree. Wires may be stripped of their insulation at their ends and/or intermediate locations to electrically connect the stripped ends or stripped intermediate locations to other wires and/or components. The shrink back is defined as the distance the insulation permanently moves from a point at which it has been initially stripped. Wire manufacturing processes can affect the degree of shrink back experienced. Excessive shrink back can result in exposure of wire, i.e., exposure of current-carrying conductor, which may be dangerous and/or detrimental to the operation of a PV system.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Some embodiments herein include an anti-shrink back device that mechanically tightens around the end of insulation of an insulated conductor to inhibit, prevent, or reduce the likelihood of insulation of an insulated wire shrinking back from its original location. The anti-shrink back device may be mechanically tightened around the insulation by crimping, one or more clamps, or other suitable mechanical tightening method(s) or device(s). For simplicity in the discussion that follows, the mechanical tightening is described in terms of crimping. However, it will be understood, with the benefit of the present disclosure, that references herein to “crimp” or “crimping” may apply equally to other mechanical tightening methods or devices.

In an embodiment, an anti-shrink back device is positionable at least partially around insulation of an electrical conductor at an end of the insulation adjacent to an uninsulated segment of the electrical conductor. The anti-shrink back device includes a band crimpable (or more generally, mechanically tightenable) at least partially around the insulation at the end of the insulation adjacent to the uninsulated segment to secure or inhibit movement of the end of the insulation longitudinally relative to the electrical conductor.

In another embodiment, a system includes an electrical conductor and an anti-shrink back device. The electrical conductor includes an insulated segment surrounded by insulation and an uninsulated segment extending from the insulated segment. The uninsulated segment is not surrounded by the insulation. The anti-shrink back device includes a band crimped at least partially around the insulation in the insulated segment at an end of the insulation adjacent to the uninsulated segment to secure or inhibit shrink back of the end of the insulation longitudinally relative to the electrical conductor.

In another embodiment, an anti-shrink back device includes a band positionable on an end of insulation that surrounds an electrical conductor on an insulated segment of the electrical conductor. The end of the insulation in the insulated segment is adjacent to an uninsulated segment of the electrical conductor. The band is crimpable on the end of the insulation to lock the insulation longitudinally in place with respect to the electrical conductor. The band is not electrically coupled to the uninsulated segment of the electrical conductor.

In another embodiment, a method includes stripping insulation from an end of a drop line to expose an end of a drop line conductor included in the drop line. The method includes crimping a first band of a first anti-shrink back device around an end of the insulation of the drop line that is adjacent to the exposed end of the drop line conductor to inhibit movement of the end of the insulation of the drop line longitudinally relative to the drop line conductor. The method includes stripping insulation from an intermediate segment of a feeder cable to expose an intermediate segment of a feeder cable conductor included in the feeder cable. The method includes crimping a second band of a second anti-shrink back device around an end of the insulation of the feeder cable that is adjacent to the intermediate segment of the feeder cable conductor to inhibit movement of the end of the insulation of the feeder cable longitudinally relative to the feeder cable conductor. The method includes electrically coupling the exposed end of the drop line conductor to the exposed intermediate segment of the feeder cable conductor. The method includes forming a mold structure that surrounds the first and second anti-shrink back devices and the electrically coupled exposed end and the exposed intermediate segment.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example operating environment in which anti-shrink back devices may be implemented;

FIG. 2 illustrates an example of a lead assembly of FIG. 1;

FIG. 3 is a longitudinal cross-sectional view of a joint of FIG. 2 in which anti-shrink back devices may be implemented;

FIG. 4 illustrates another joint in which anti-shrink back devices may be implemented;

FIG. 5 illustrates another joint in which anti-shrink back devices may be implemented;

FIGS. 6A-6B illustrate an example anti-shrink back device that may be implemented in any of the joints of FIGS. 2-5 or other environments;

FIG. 7A illustrates another example anti-shrink back device that may be implemented in any of the joints of FIGS. 2-5 or other environments;

FIG. 7B is a longitudinal cross-sectional view of a portion of a joint that includes the anti-shrink back device of FIG. 7A;

FIG. 8A illustrates another example anti-shrink back device that may be implemented in any of the joints of FIGS. 2-5 or other environments;

FIG. 8B is a longitudinal cross-sectional view of a portion of a joint that includes the anti-shrink back device of FIG. 8A;

FIG. 9A illustrates another example anti-shrink back device that may be implemented in any of the joints of FIGS. 2-5 or other environments;

FIG. 9B is a longitudinal cross-sectional view of a portion of a joint that includes the anti-shrink back device of FIG. 9A;

FIG. 10A illustrates another example anti-shrink back device that may be implemented in any of the joints of FIGS. 2-5 or other environments;

FIG. 10B is a longitudinal cross-sectional view of a portion of a joint that includes the anti-shrink back device of FIG. 10A;

FIG. 11 illustrates another example anti-shrink back device that may be implemented in any suitable joint or other suitable environment; and

FIG. 12 illustrates another example anti-shrink back device that may be implemented in any of the joints of FIGS. 2-5 or other environments, all according to at least one embodiment described in the present disclosure.

### DESCRIPTION OF EMBODIMENTS

Some insulated wires end with a terminal connector that allows the wire to be electrically coupled through the terminal connector to a complementary connector on another wire or electronic component. To install such a terminal connector on the wire, the insulation may first be stripped from the end of the wire. The terminal connector typically includes first and second crimp portions. The first crimp portion is crimped around the stripped portion of the wire. The first crimp portion provides both electrical connectivity and a mechanical connection between the stripped wire and the terminal connector. The second crimp portion is crimped around the end of the insulation adjacent to the stripped portion of the wire. The second crimp portion provides a second mechanical connection between the insulated wire and the terminal connector to prevent, or at least reduce the likelihood of, the insulated wire separating from the terminal connector, e.g., when the insulated wire/terminal connector is unplugged from the complementary connector or component.

Some embodiments herein include an anti-shrink back device that crimps exclusively around the end of the insulation without crimping around the bare wire. In contrast to the foregoing terminal connectors whose purpose is to electrically/mechanically couple the terminal connector to the wire and prevent separation of the terminal connector from the wire due to pulling forces applied during use, embodiments of the anti-shrink back device herein prevent (or at least reduce the likelihood) of insulation of an insulated wire shrinking back from its original location. In view of the differences between anti-shrink back devices herein and terminal connectors, the anti-shrink back devices may not be electrically coupled to the bare wire, may be electrically insulated from the bare wire, may not be mechanically secured directly to the bare wire, and/or may be mechanically secured directly to the insulation exclusive of the bare wire.

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

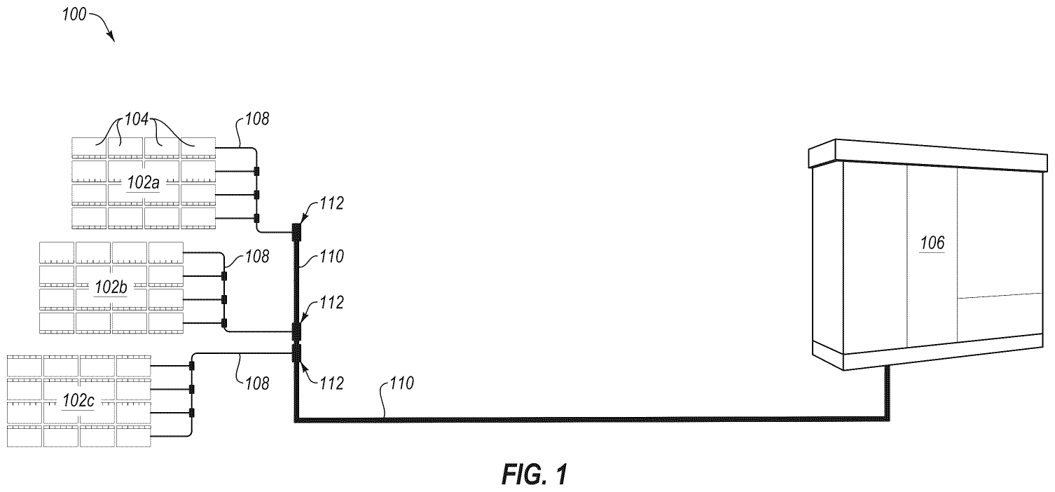

FIG. 1 illustrates an example operating environment 100 in which anti-shrink back devices may be implemented, arranged in accordance with at least one embodiment herein. While discussed in the context of a PV system or environment, embodiments herein may be implemented to inhibit, prevent, and/or reduce shrink back of insulation on any insulated wires or cables in any environment.

The environment 100 includes one or more arrays 102a, 102b, 102c (hereinafter “arrays 102”) of PV modules (or solar panels) 104 electrically coupled to an inverter 106 through one or more wire harnesses 108 and a lead assembly 110. Each wire harness 108 includes a wire harness connector 112 to electrically and mechanically couple the corresponding wire harness 108 to the lead assembly 110.

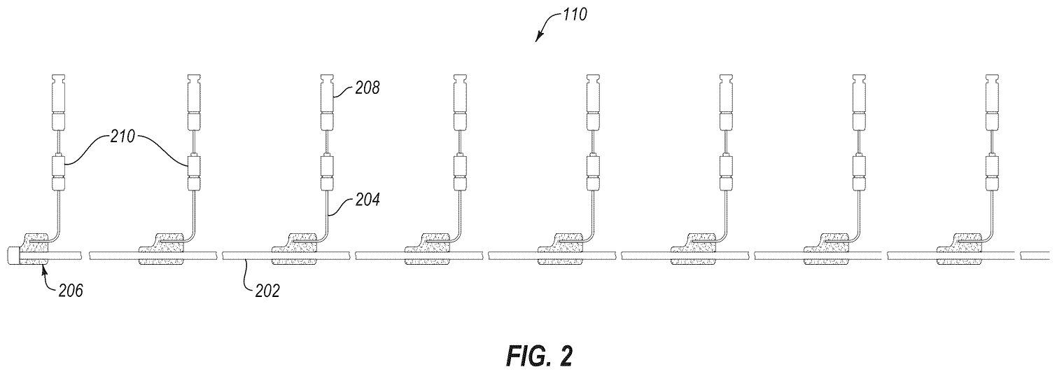

FIG. 2 illustrates an example of the lead assembly 110 of FIG. 1, arranged in accordance with at least one embodiment herein. The lead assembly 110 includes a feeder cable 202 and drop lines 204 electrically coupled thereto at joints 206.

Feeder cable 202 may be constructed of 6 gauge to 1000 MCM wire or other suitable wire, with the specific wire chosen based on factors such as the number of associated drop lines 204, a distance between the connection and downstream inverter, and whether the feeder cable 202 is of aluminum or copper construction or other material.

Each drop line 204 terminates with a drop line connector 208 which may electrically and mechanically couple the drop line 204 to a corresponding wire harness connector 112 of a wire harness 108. The drop lines 204 may be constructed of 18 to 4 gauge wire or other suitable wire, and drop line connectors 208 may be off-the-shelf connectors such as MC4/PV-KBT4/61-UR & PV-KST4/61-UR from Multi-Contact of Windsor, CA. As illustrated, each drop line 204 includes an inline fuse 210. In other embodiments, one or more and up to all of the drop lines 204 may lack any inline fuse(s).

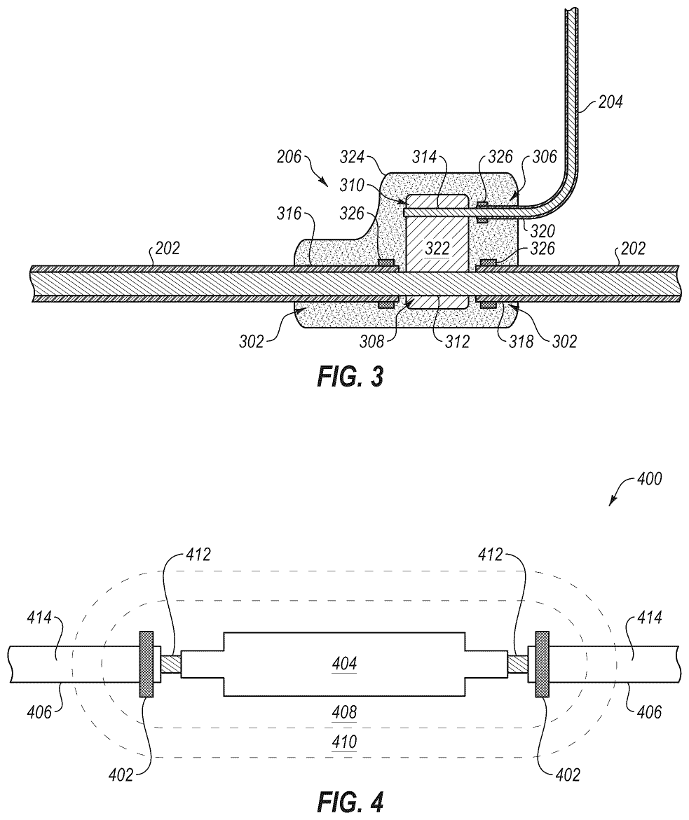

FIG. 3 is a longitudinal cross-sectional view of one of the joints 206 of FIG. 2, arranged in accordance with at least one embodiment herein. Within each joint 206, the feeder cable 202 and drop line 204 each include one or more insulated segments 302, 304, 306 and one or more uninsulated segment 308, 310. The feeder cable 202 and drop line 204 each includes an electrical conductor 312, 314 that extends through the various insulated and uninsulated segments 302, 304, 306, 308, 310. The electrical conductors 312, 314 may each include a wire, cable, or the like. The feeder cable 202 and drop line 204 each additionally includes insulation 316, 318, 320 (or an insulation jacket) that surrounds the corresponding electrical conductor 312, 314 within the corresponding insulated segment 302, 304, 306.

As further illustrated in FIG. 3, a compression lug 322 or other suitable electrical connector or method (e.g., soldering, splicing, crimping, or the like) electrically and mechanically couples the exposed electrical conductors 312, 314 of the uninsulated segments 308, 310 of the feeder cable 202 and the drop line 204 together within the joint 206. Portions of the drop line 204 and the feeder cable 202, including the insulated and the uninsulated segments 302, 304, 306, 308, 310, are surrounded by one or more molds 324 (e.g., undermold and/or overmold) for environmental protection. The one or more molds 324 may include RTP 2099E×127663 from RTP Co. of Winona, MN that has been applied by injection molding, RTP 199×124807 from RTP Co of Winona, MN that has been applied by injection molding, and/or other suitable material(s) applied and/or formed via injection molding or other suitable process(es).

FIG. 3 further illustrates anti-shrink back devices 326 (hereinafter “devices 326” or “device 326”) coupled to the insulation 316, 318, 320 adjacent to or just beyond the exposed conductor 312, 314 of the uninsulated segments 308, 310 of the drop line 204 and the feeder cable 202. As used herein, an anti-shrink back device (such as any of the devices 326) coupled or crimped to insulation (such as the insulation 316, 318, 320) is adjacent to or just beyond exposed conductor (such as the exposed conductor 312, 314) of an uninsulated segment (such as the uninsulated segments 308, 310) if, longitudinally, a side of the device closest to the uninsulated segment is less than a threshold distance from the uninsulated segment. The threshold distance may be, e.g., 5 centimeters (cm), 4 cm, 3 cm, 2.5 cm, 2 cm, 1.5 cm, 1 cm, or other suitable distance. In some embodiments, each anti-shrink back device 326 may be at least 4 millimeters (mm) (or other minimum distance) from the exposed conductor 312, 314 of the uninsulated segments 308, 310.

Each device 326 may include a band crimped at least partially around the insulation 316, 318, 320 in the corresponding insulated segment 302, 304, 306 at an end of the corresponding insulation 316, 318, 320 adjacent to the corresponding uninsulated segment 308, 310 to secure or inhibit shrink back of the corresponding end of the insulation 316, 318, 320 longitudinally relative to the electrical conductor 312, 314.

The devices 326 may compress the insulation 316, 318, 320, in some embodiments displacing some of the insulation 316, 318, 320 material, to provide a holding force to inhibit or prevent the insulation 316, 318, 320 from shrinking back from the exposed conductor 312, 314 of the uninsulated segments 308, 310. Alternatively or additionally, the devices 326 may increase friction between the insulation 316, 318, 320 and underlying conductor to inhibit, prevent, and/or reduce shrink back of the insulation 316, 318, 320 relative to the underlying wire. Further, the mold 324 may generally hold the devices 326 in place, e.g., by providing a holding force to inhibit, prevent, and/or reduce the likelihood of the devices 326 moving under shrink back forces applied by the insulation 316, 318, 320.

Other solutions rely on adhesion of the mold 324 to grip the insulation 316, 318, 320 to prevent shrink back. Embodiments herein, however, rely on the holding force of the devices 326 against the insulation 316, 318, 320 and optionally of the mold 324 on the devices 326.

Embodiments of anti-shrink back devices as described herein, such as the devices 326, may be installed in any suitable manner. For example, during manufacturing, and before or after compressing the compression lug 322 on the feeder cable 202 and drop line 204 (and specifically on their exposed conductors 312, 314), the devices 326 may be positioned on the feeder cable 202 or drop line 204 (e.g., just beyond the exposed conductors 312, 314 on the insulation 316, 318, 320) and then crimped onto the insulation 316, 318, 320. Next, the mold 324 may be formed surrounding the exposed conductor 312, 314, the compression lug 322, and the devices 326, thereby capturing the devices 326 and locking them in place. In turn, the insulation 316, 318, 320 is captured by the locked-in-place devices 326 against the corresponding conductor 312, 314 within the insulation 316, 318, 320 to lock the insulation 316, 318, 320 in place to prevent shrink back.

FIG. 4 illustrates another joint 400 in which anti-shrink back devices 402 may be implemented, arranged in accordance with at least one embodiment herein. The joint 400 in FIG. 4 includes an inline fuse 404 (such as the inline fuse 210 of FIG. 2) of a drop line 406 surrounded by an undermold 408 which, in turn, is surrounded by an overmold 410. As illustrated, the anti-shrink back devices 402 are positioned just beyond exposed conductor 412 (e.g., just beyond an uninsulated segment of the conductor 412) of the drop line 406 and crimped in place to lock insulation 414 against the conductor 412 and prevent shrink back. The joint 400, each of the anti-shrink back devices 402, the inline fuse 404, the drop line 406, the undermold 408, the overmold 410, the conductor 412, and/or the insulation 414 may respectively include, be included, or correspond to other joints, anti-shrink back devices, inline fuses, drop lines, undermolds, overmolds, conductors, and/or insulation described herein.

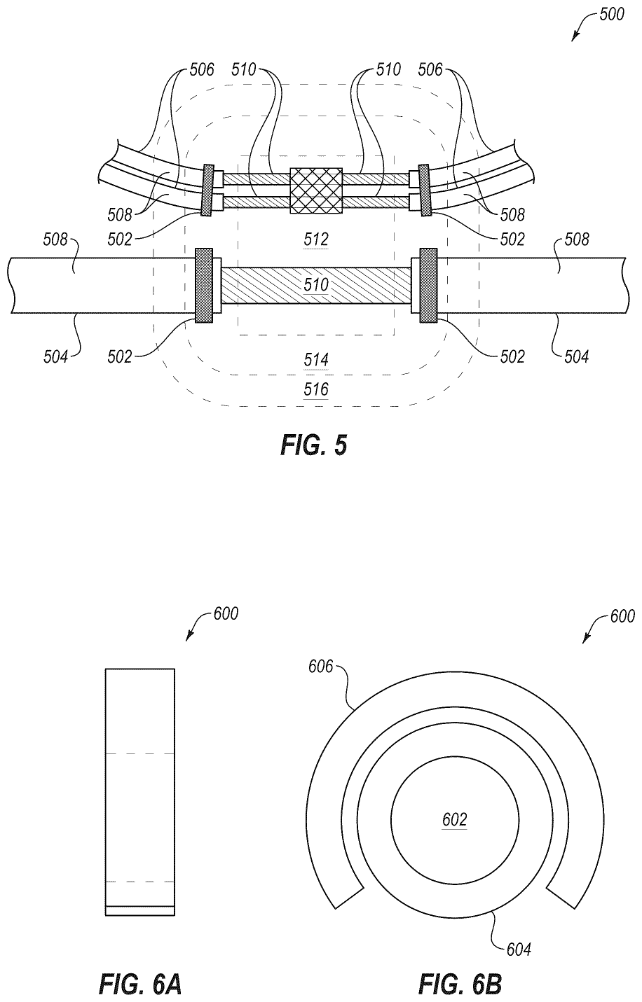

FIG. 5 illustrates another joint 500 in which anti-shrink back devices 502 may be implemented, arranged in accordance with at least one embodiment herein. FIG. 5 is similar in many respects to FIG. 3 in depicting a joint 500 in which a feeder cable (or “trunk wire”) 504 is electrically coupled to a drop line 506. FIG. 5 differs from FIG. 3 in that in FIG. 5, the feeder cable 504 is electrically coupled to four drop lines 506 at the joint 500, rather than to just one drop line 204 at the joint 206 in FIG. 3. As in FIG. 3, all five insulated conductors (e.g., feeder cable 504 and drop lines 506) have insulation 508 removed to expose bare conductor 510 that may be electrically coupled together using a compression lug (or “BLA crimp lug”) 512. The anti-shrink back devices 502 are positioned on the insulation 508 adjacent to or just beyond the exposed conductor 510 of the feeder cable 504 and drop lines 506 and crimped in place to lock the insulation 508 against the corresponding conductor 510 and inhibit, prevent, and/or reduce shrink back. The exposed conductor 510, the compression lug 512, and the devices 502 are surrounded by an undermold 514, which is in turn surrounded by an overmold 516. The joint 500, each of the anti-shrink back devices 502, the feeder cable 504, each of the drop lines 506, each of the insulation 508, each of the conductors 510, the compression lug 512, the undermold 514, and/or the overmold 516 may respectively include, be included in, or correspond to other joints, anti-shrink back devices, feeder cables, drop lines, insulation, conductors, compression lugs, undermold, and/or overmold described herein.

In general, embodiments of the anti-shrink back devices described herein may include a band crimpable at least partially around insulation at an end of the insulation adjacent to an uninsulated segment of conductor to secure or inhibit movement of the end of the insulation longitudinally relative to the conductor. Each band may be a circular or semi-circular band or a band of any other suitable shape. Each anti-shrink back device may include metal or other suitable material that is deformable, e.g., crimpable, under suitable force by a suitable tool, e.g., a crimping tool, to crimp around insulation of an insulated conductor and substantially retain its deformed, e.g., crimped, shape thereafter. Various specific example anti-shrink back devices will now be described.

FIGS. 6A-6B illustrate an example anti-shrink back device 600 that may be implemented in any of the joints 206, 400, 500 of FIGS. 2-5 or other environments, arranged in accordance with at least one embodiment herein. For example, the anti-shrink back device 600 may be implemented as any of the anti-shrink back devices 326, 402, 502 of FIGS. 3-5. FIG. 6A depicts a side view of the anti-shrink back device 600 (with dashed lines generally indicating an approximate location of the conductor 604 relative to the anti-shrink back device 600) after being crimped onto the insulated conductor and FIG. 6B depicts a front view of the anti-shrink back device 600 and insulated conductor prior to crimping.

FIG. 6B further depicts an example insulated conductor on which the anti-shrink back device 600 may be crimped, the insulated conductor including an electrical conductor 602 and corresponding insulation 604.

As illustrated, the anti-shrink back device 600 includes a band 606 having, at least prior to being crimped onto an insulated conductor, a generally C-shaped or semi-circular configuration. After being crimped, the band 606 may be deformed and the gap illustrated between ends of the band 606 in FIG. 6B may be reduced or disappear altogether.

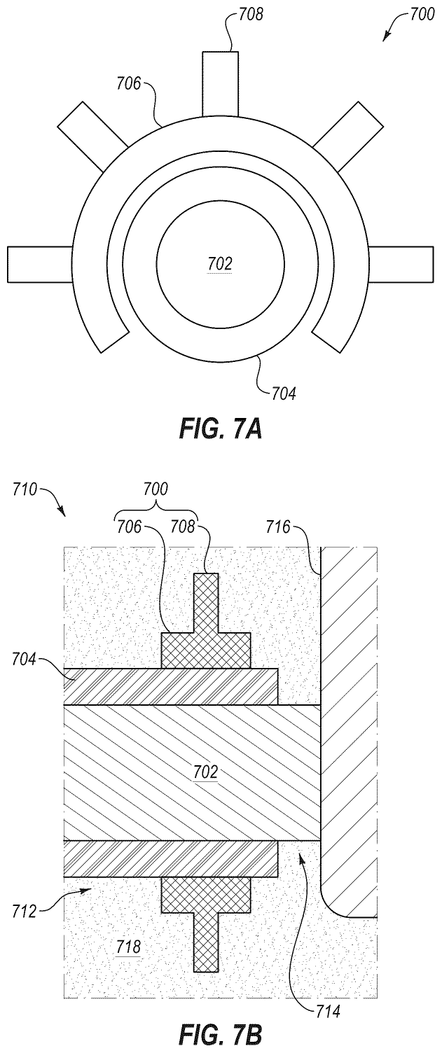

FIG. 7A illustrates another example anti-shrink back device 700 that may be implemented in any of the joints 206, 400, 500 of FIGS. 2-5 or other environments, arranged in accordance with at least one embodiment herein. For example, the anti-shrink back device 700 may be implemented as any of the anti-shrink back devices 326, 402, 502 of FIGS. 3-5. FIG. 7A further depicts an example insulated conductor on which the anti-shrink back device 700 may be crimped, the insulated conductor including an electrical conductor 702 and corresponding insulation 704.

The anti-shrink back device 700 generally includes a band 706 having, at least prior to being crimped onto the insulated conductor, a generally C-shaped or semi-circular configuration. After being crimped, the band 706 may be deformed and the gap illustrated between ends of the band 706 in FIG. 7A may be reduced or disappear altogether. As illustrated in FIG. 7A, the anti-shrink back device 700 may further include one or more protrusions 708 (only one of which is labeled in FIG. 7A for simplicity) that extend radially outward from the band 702. The protrusions 708 may increase mechanical engagement between the anti-shrink back device 700 and a surrounding mold (e.g., undermold or overmold).

The anti-shrink back device 700 (and other anti-shrink back devices herein) is crimped around the insulation 704 to lock (or at least reduce or inhibit relative longitudinal movement of) the insulation 704 longitudinally relative to the conductor 702, e.g., by increasing friction between the insulation 704 and the conductor 702. Even so, under sufficiently high shrink back forces, the insulation 704 and anti-shrink back device 700 may move longitudinally relative to the conductor 702. Such shrink back may be mitigated in joints, such as the joints 206, 400, 500 of FIGS. 2-5, by covering the anti-shrink back device 700 and the insulated and uninsulated segments of the conductor with a mold such that the mold locks (or at least reduces or inhibits relative longitudinal movement of) the anti-shrink back device 700, and thereby the insulation 704, longitudinally relative to the conductor 702, e.g., by engaging the anti-shrink back device 700. Inclusion of the protrusions 708 in addition to the band 706 increases the engagement between the mold and the anti-shrink back device 700 relative to anti-shrink back devices that lack such protrusions, such as the anti-shrink back device 600 of FIGS. 6A-6B.

FIG. 7B is a longitudinal cross-sectional view of a portion of a joint 710 that includes the anti-shrink back device 700 of FIG. 7A, arranged in accordance with at least one embodiment herein. As illustrated in FIG. 7B, the anti-shrink back device 700 is crimped around an insulated segment 712 of the conductor 702, the conductor 702 surrounded by the insulation 704 in the insulated segment 712. The anti-shrink back device 700 is crimped around an end of the insulated segment 712 adjacent to an uninsulated segment 714 of the conductor 702 to inhibit, prevent, or reduce longitudinal movement of the insulation 704 relative to the uninsulated segment 714 and/or a corresponding compression lug 716.

FIG. 7B further depicts a mold 718 that surrounds the anti-shrink back device 700, the insulated and uninsulated segments 712, 714 of the conductor 702, and the compression lug 716. As illustrated, the protrusions 708 may increase engagement between the mold 718 and the anti-shrink back device 700 to reduce a likelihood of the anti-shrink back device 700, and thereby the end of the insulation 704, experiencing any longitudinal movement (or shrink back) relative to the mold 718 and thereby the uninsulated segment 714 of the conductor 702.

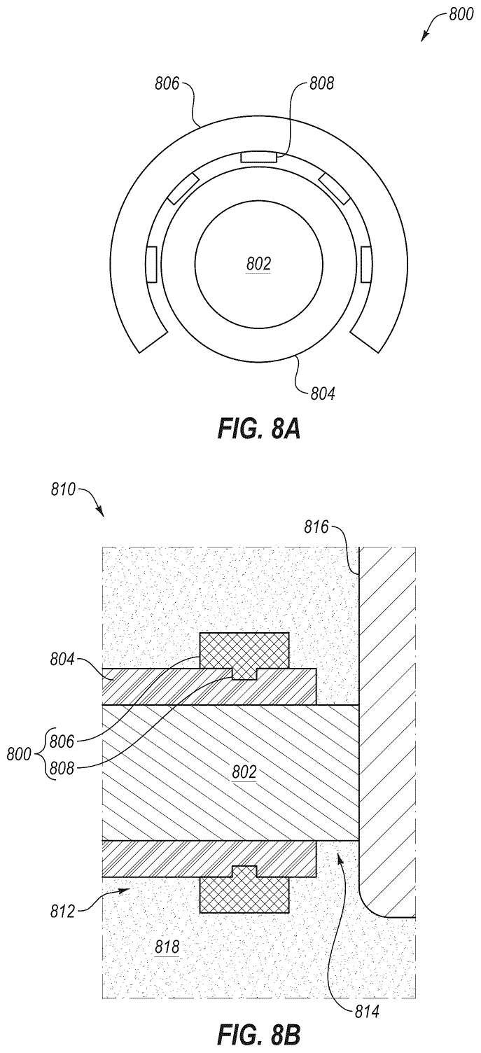

FIG. 8A illustrates another example anti-shrink back device 800 that may be implemented in any of the joints 206, 400, 500 of FIGS. 2-5 or other environments, arranged in accordance with at least one embodiment herein. For example, the anti-shrink back device 800 may be implemented as any of the anti-shrink back devices 326, 402, 502 of FIGS. 3-5. FIG. 8A further depicts an example insulated conductor on which the anti-shrink back device 800 may be crimped, the insulated conductor including an electrical conductor 802 and corresponding insulation 804.

The anti-shrink back device 800 generally includes a band 806 having, at least prior to being crimped onto the insulated conductor, a generally C-shaped or semi-circular configuration. After being crimped, the band 806 may be deformed and the gap illustrated between ends of the band 806 in FIG. 8A may be reduced or disappear altogether. As illustrated in FIG. 8A, the anti-shrink back device 800 may further include one or more protrusions 808 (only one of which is labeled in FIG. 8A for simplicity) that extend radially inward from the band 802. The protrusions 808 may increase mechanical engagement between the anti-shrink back device 800 and the insulation 804.

The anti-shrink back device 800 (and other anti-shrink back devices herein) is crimped around the insulation 804 to lock (or at least reduce or inhibit relative longitudinal movement of) the insulation 804 longitudinally relative to the conductor 802, e.g., by increasing friction between the insulation 804 and the conductor 802. Even so, under sufficiently high shrink back forces, the insulation 804 and anti-shrink back device 800 may move longitudinally relative to the conductor 802. Such shrink back may be mitigated in joints, such as the joints 206, 400, 500 of FIGS. 2-5, by covering the anti-shrink back device 800 and the insulated and uninsulated segments of the conductor with a mold such that the mold locks (or at least reduces or inhibits relative longitudinal movement of) the anti-shrink back device 800, and thereby the insulation 804, longitudinally relative to the conductor 802, e.g., by engaging the anti-shrink back device 800. Inclusion of the protrusions 808 may increase the engagement between the anti-shrink back device 800 and the insulation 804 relative to anti-shrink back devices that lack such protrusions, such as the anti-shrink back devices 600, 700 of FIGS. 6-7.

FIG. 8B is a longitudinal cross-sectional view of a portion of a joint 810 that includes the anti-shrink back device 800 of FIG. 8A, arranged in accordance with at least one embodiment herein. As illustrated in FIG. 8B, the anti-shrink back device 800 is crimped around an insulated segment 812 of the conductor 802, the conductor 802 surrounded by the insulation 804 in the insulated segment 812. The anti-shrink back device 800 is crimped around an end of the insulated segment 812 adjacent to an uninsulated segment 814 of the conductor 802 to inhibit, prevent, or reduce longitudinal movement of the insulation 804 relative to the uninsulated segment 814 and/or a corresponding compression lug 816.

FIG. 8B further depicts a mold 818 that surrounds the anti-shrink back device 800, the insulated and uninsulated segments 812, 814 of the conductor 802, and the compression lug 816. As illustrated, the protrusions 808 may increase engagement between the anti-shrink back device 800 and the insulation 804 to reduce a likelihood of the insulation 804 slipping relative to the anti-shrink back device 800 as locked in place by the mold 818 and thereby shrinking back relative to the uninsulated segment 814 of the conductor 802.

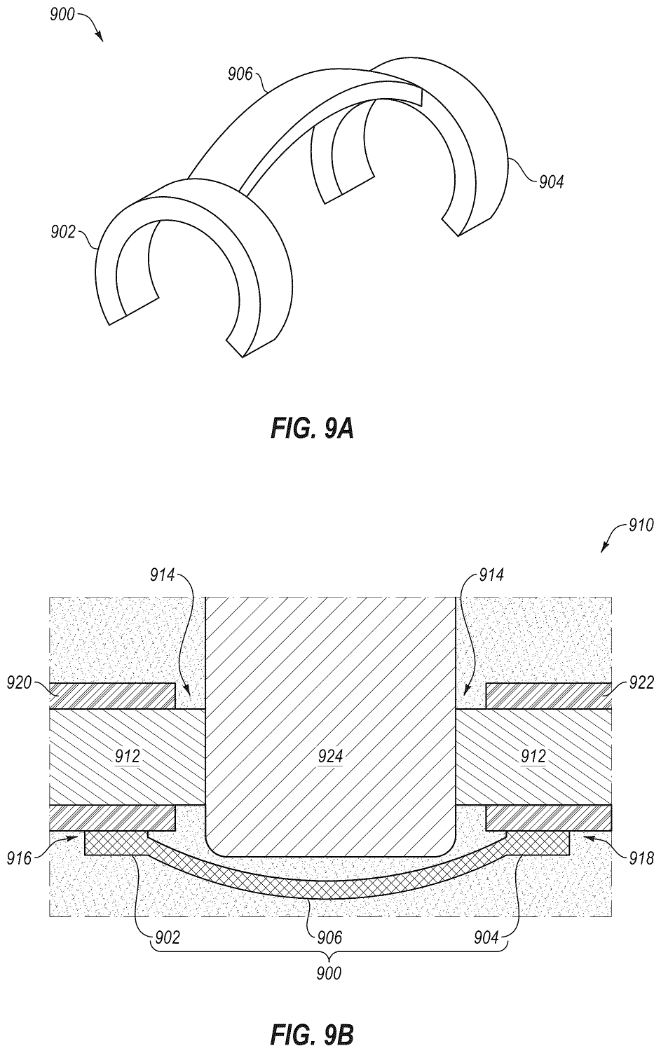

FIG. 9A illustrates another example anti-shrink back device 900 that may be implemented in any of the joints 206, 400, 500 of FIGS. 2-5 or other environments, arranged in accordance with at least one embodiment herein. For example, the anti-shrink back device 900 may be implemented as any of the anti-shrink back devices 326, 402, 502 of FIGS. 3-5.

The anti-shrink back device 900 generally includes first and second bands 902, 904 coupled together by a connector 906. Each of the bands 902, 904 has, at least prior to being crimped onto the insulated conductor, a generally C-shaped or semi-circular configuration. After being crimped, each of the bands 902, 904 may be deformed and the gaps illustrated between ends of the bands 902, 904 in FIG. 9A may be reduced or disappear altogether. The anti-shrink back device 900 may be used to, e.g., secure insulation of two insulated segments of a conductor on opposing sides of a corresponding uninsulated segment of the conductor, as described in more detail with respect to FIG. 9B.

FIG. 9B is a longitudinal cross-sectional view of a portion of a joint 910 that includes the anti-shrink back device 900 of FIG. 9A, arranged in accordance with at least one embodiment herein. The joint includes a conductor 912 having an uninsulated segment 914 and first and second insulated segments 916, 918 on opposing sides of the uninsulated segment 914. The conductor 912 is surrounded by first and second insulation 920, 922 in the insulated segments 916, 918 and bare (at least with respect to the insulation 920, 922) in the uninsulated segment 914. The first band 902 of the anti-shrink back device 900 is crimped around an end of the first insulated segment 916 adjacent to the uninsulated segment 914 of the conductor 912 to inhibit, prevent, or reduce longitudinal movement of the first insulation 920 relative to the uninsulated segment 914 and/or a corresponding compression lug 924. Similarly, the second band 904 of the anti-shrink back device 900 is crimped around an end of the second insulated segment 918 adjacent to the uninsulated segment 914 of the conductor 912 to inhibit, prevent, or reduce longitudinal movement of the insulation 922 relative to the uninsulated segment 914 and/or the compression lug 924.

As illustrated in FIG. 9B, a length of the connector 906 (e.g., its longitudinal dimension) exceeds a length of the uninsulated segment 914 of the conductor 912. As such, the connector 906 spans the length of the uninsulated segment 914 so as to couple the first and second bands 902, 904 together across the uninsulated segment 914.

Inclusion of the connector 906 in the anti-shrink back device 900 may, in effect, cancel out opposing shrink back forces of the first and second insulation 920, 922. In particular, shrink back of the first insulation 920 in the first insulated segment 916 may urge the first insulation 920, and thereby the first band 902 of the anti-shrink back device 900 leftward in FIG. 9B. On the other hand, shrink back of the second insulation 922 in the second insulated segment 918 may urge the second insulation 922, and thereby the second band 904 of the anti-shrink back device 900, rightward in FIG. 9B. Because the first and second bands 902, 904 are coupled together via the connector 906, the shrink back forces that urge the first insulation 920 and the first band 902 in one direction (e.g., leftward in FIG. 9B) may be completely or partially cancelled out or counteracted by the shrink back forces that urge the second insulation 922 and the second band 904 in the opposite direction (e.g., rightward in FIG. 9B).

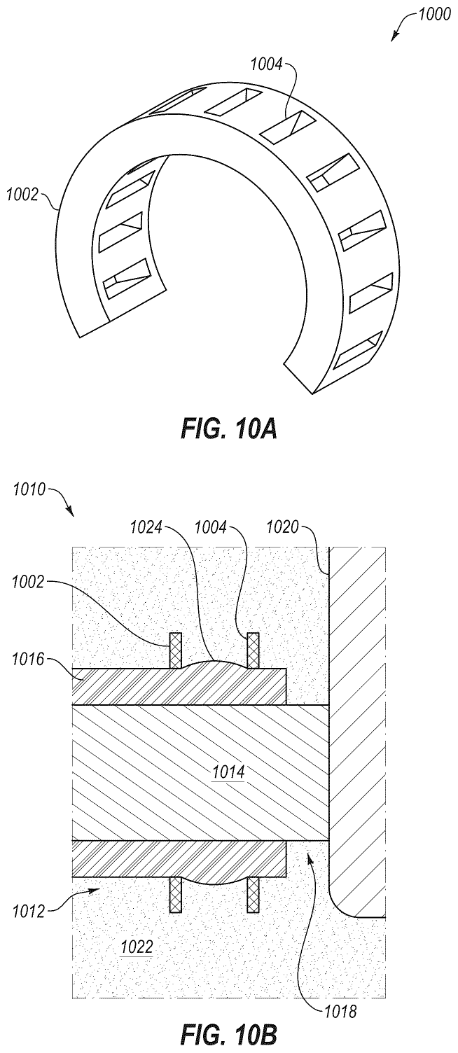

FIG. 10A illustrates another example anti-shrink back device 1000 that may be implemented in any of the joints 206, 400, 500 of FIGS. 2-5 or other environments, arranged in accordance with at least one embodiment herein. For example, the anti-shrink back device 1000 may be implemented as any of the anti-shrink back devices 326, 402, 502 of FIGS. 3-5. FIG. 10A depicts a perspective view of the anti-shrink back device 1000.

As illustrated, the anti-shrink back device 1000 includes a band 1002 having, at least prior to being crimped onto an insulated conductor, a generally C-shaped or semi-circular configuration. After being crimped, the band 1002 may be deformed and the gap illustrated between ends of the band 1002 in FIG. 10A may be reduced or disappear altogether. Further, the band 1002 defines openings 1004 (only one of which is labeled in FIG. 10A for simplicity) that extend radially through the band 1002.

FIG. 10B is a longitudinal cross-sectional view of a portion of a joint 1010 that includes the anti-shrink back device 1000 of FIG. 10A, arranged in accordance with at least one embodiment herein. As illustrated in FIG. 10B, the anti-shrink back device 1000 is crimped around an insulated segment 1012 of a conductor 1014, the conductor 1014 surrounded by insulation 1016 in the insulated segment 1012. The anti-shrink back device 1000 is crimped around an end of the insulated segment 1012 adjacent to an uninsulated segment 1018 of the conductor 1014 to inhibit, prevent, or reduce longitudinal movement of the insulation 1016 relative to the uninsulated segment 1018 and/or a corresponding compression lug 1020.

FIG. 10B further depicts a mold 1022 that surrounds the anti-shrink back device 1000, the insulated and uninsulated segments 1012, 1018 of the conductor 1014, and the compression lug 1020. As illustrated, the openings 1004 may increase engagement between the anti-shrink back device 1000 and the insulation 1016. In particular, when the anti-shrink back device 1000 is crimped onto the insulated segment 1012 around the insulation 1016, it may squeeze or compress the insulation 1016 and/or cause portions of the insulation 1016 that are radially inward of each of the openings 1004 prior to crimping to at least partially extend or protrude radially outward into the openings 1004 as protrusions 1024 (only one of which is labeled in FIG. 10B for simplicity). The protrusions 1024 of the insulation 1016 may engage with sidewalls of the band 1002 that define the openings 1004 to reduce a likelihood of the insulation 1016 slipping relative to the anti-shrink back device 1000 as locked in placed by the mold 1022 and thereby shrinking back relative to the uninsulated segment 1018 of the conductor 1014.

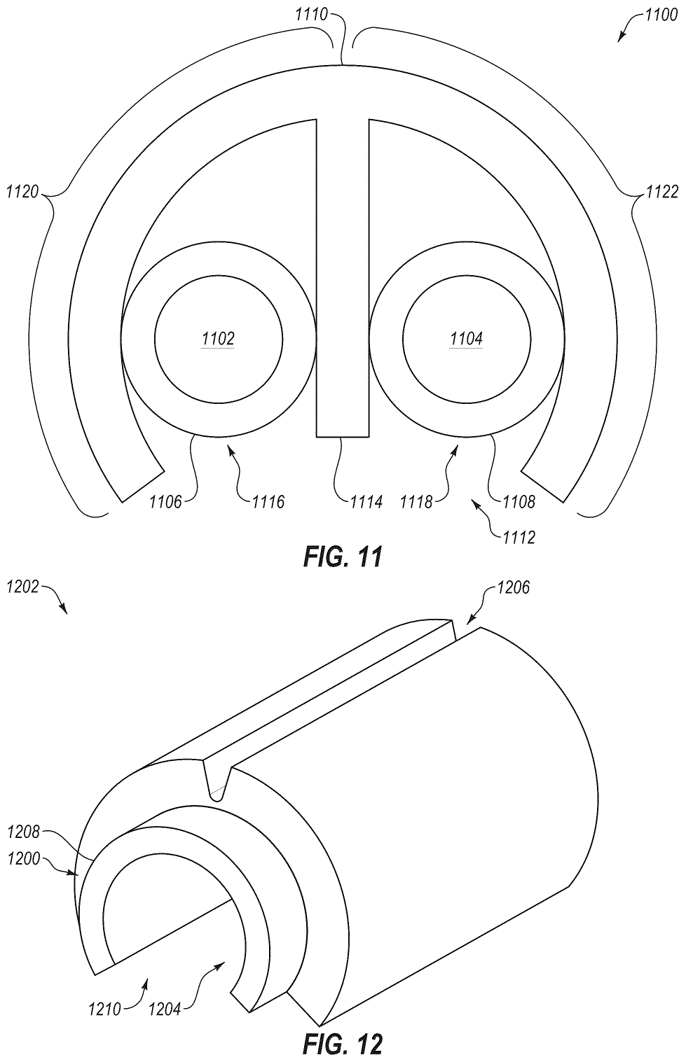

FIG. 11 illustrates another example anti-shrink back device 1100 that may be implemented in any suitable joint or other suitable environment, arranged in accordance with at least one embodiment herein. For example, the anti-shrink back device 1100 may be implemented in place of two of the anti-shrink back devices 502 on adjacent drop lines 506 of FIG. 5. FIG. 11 further depicts two adjacent insulated conductors on which the anti-shrink back device 800 may be crimped, the insulated conductors each including an electrical conductor 1102, 1104 and corresponding insulation 1106, 1108.

As illustrated, the anti-shrink back device 1100 includes a band 1110 having, at least prior to being crimped onto an insulated conductor, a generally C-shaped or semi-circular configuration. After being crimped, the band 1002 may be deformed and the gap illustrated between ends of the band 1110 in FIG. 11 may be reduced or disappear altogether.

The band 1110 at least partially encloses an area 1112. The anti-shrink back device 1100 additionally includes a separator 1114 that extends from the band 1110 and divides the area 1112 into separate first and second areas 1116, 1118. Further, the band 1002 defines openings 1004 (only one of which is labeled in FIG. 10A for simplicity) that extend radially through the band 1002. The separator 1114 and a first portion 1120 of the band 1110 define the first area 1116 and may be crimped at least partially around the insulation 1106 in an insulated segment of the conductor 1102 at an end of the insulation 1106 adjacent to an uninsulated segment of the conductor 1102. The separator 1114 and a second portion 1122 of the band 1110 define the second area 1118 and may be crimped at least partially around the insulation 1108 in an insulated segment of the conductor 1104 at an end of the insulation 1108 adjacent to an uninsulated segment of the conductor 1104. Thus, the anti-shrink back device 1100 may be used to prevent, inhibit, and/or reduce shrink back of insulation of two insulated cables that are parallel at least in a vicinity of the anti-shrink back device 1100.

FIG. 12 illustrates another example anti-shrink back device 1200 that may be implemented in any of the joints 206, 400, 500 of FIGS. 2-5 or other environments, arranged in accordance with at least one embodiment herein. For example, the anti-shrink back device 1200 may be implemented as any of the anti-shrink back devices 326, 402, 502 of FIGS. 3-5. FIG. 12 further illustrates a compression lug 1202 with which the anti-shrink back device 1200 may be integrally formed or coupled. The compression lug 1202 may include, be included, or correspond to any of the other compression lugs described herein.

The compression lug 1202 defines first and second crimp channels 1204, 1206, each configured to receive therein an uninsulated segment of a conductor. For example, the first crimp channel 1204 may be configured to receive therein the uninsulated segment 308 of the conductor 312 of the feeder cable 202 of FIG. 3, while the second crimp channel 1206 may be configured to receive therein the uninsulated segment 310 of the conductor 314 of the drop line 204. After positioning the corresponding uninsulated segment of the corresponding conductor in the corresponding crimp channel 1204, 1206, the compression lug 1202 may then be crimped so as to crimp the first crimp channel 1204 around the uninsulated segment of one of the conductors and to crimp the second crimp channel 1206 around the uninsulated segment of the other of the conductors. In this manner, the compression lug 1202 may be electrically coupled to each of the conductors, thereby electrically coupling the two conductors together.

The anti-shrink back device 1200 includes a band 1208 that defines a third crimp channel 1210 that extends from the first crimp channel 1204. The third crimp channel 1210 is configured to receive therein an end of an insulated segment of the conductor in the first crimp channel 1204. For example, the third crimp channel 1210 may be configured to receive therein at least a portion of the insulated segment 302 of the conductor 312 of the feeder cable 202 of FIG. 3. After positioning the insulated segment of the conductor in the third crimp channel 1210, the band 1208 may then be crimped so as to crimp the third crimp channel 1210, and more particularly the band 1208, around the insulated segment of the conductor. In this manner, the anti-shrink back device 1200 may secure the insulation of the conductor to prevent, reduce, or inhibit shrink back of the insulation relative to the conductor.

FIG. 12 depicts one band 1208 defining the third crimp channel 1210 that extends from one end of the first crimp channel 1204. Although not depicted in FIG. 12, the anti-shrink back device 1200 may include another band that defines a fourth crimp channel that extends from an opposite end of the first crimp channel 1204. Alternatively or additionally, the anti-shrink back device 1200 may further include a band that defines a crimp channel that extends from one end of the second crimp channel 1206 and/or a band that defines a crimp channel that extends from an opposite end of the second crimp channel 1206. Thus, the anti-shrink back device 1200 may include one, two, three, or four bands in the example of FIG. 12, each of the bands being coupled or otherwise attached to the compression lug 1202 at an end of a corresponding one of the first or second crimp channels 1204, 1206.

Features of the various embodiments described herein may be implemented individually or in any combination. For example, an anti-shrink back device may include both the radially outward directed protrusions 708 of FIGS. 7A-7B as well as the radially inward directed protrusions 808 of FIGS. 8A-8B. As another example, an anti-shrink back device may include two bands coupled together by a connector as in FIGS. 9A-9B in which one or both of the bands defines one or more openings such as the openings 1004 of FIGS. 10A-10B and/or includes one or more radially directed protrusions such as the protrusions 708, 808 of FIGS. 7A-8B.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An anti-shrink back device positionable at least partially around insulation of an electrical conductor at an end of the insulation adjacent to an uninsulated segment of the electrical conductor, the anti-shrink back device comprising:
a band mechanically tightenable at least partially around the insulation at the end of the insulation adjacent to the uninsulated segment to secure or inhibit movement of the end of the insulation longitudinally relative to the electrical conductor.

2. The anti-shrink back device of claim 1, wherein after being mechanically tightened at least partially around the insulation, the anti-shrink back device is electrically insulated from the electrical conductor.

3. The anti-shrink back device of claim 1, wherein after being mechanically tightened at least partially around the insulation, the anti-shrink back device is not mechanically secured directly to the uninsulated segment of the electrical conductor.

4. The anti-shrink back device of claim 1, wherein after being mechanically tightened at least partially around the insulation, the anti-shrink back device is mechanically secured directly to the insulation exclusive of the electrical conductor.

5. The anti-shrink back device of claim 1, wherein the band comprises a semi-circular band or a circular band.

6. The anti-shrink back device of claim 1, further comprising:
a second band mechanically tightenable at least partially around second insulation at an end of the second insulation adjacent to the uninsulated segment of the electrical conductor at an opposite end of the uninsulated segment from the insulation; and
a connector that couples the band and the second band together, the connector having a length in excess of a length of the uninsulated segment of the electrical conductor.

7. The anti-shrink back device of claim 1, wherein the band is circular or semi-circular and defines a plurality of openings that extend radially through the band.

8. The anti-shrink back device of claim 1, further comprising one or more protrusions that extend radially inward from the band.

9. The anti-shrink back device of claim 1, further comprising one or more protrusions that extend radially outward from the band.

10. The anti-shrink back device of claim 1, wherein the band at least partially encloses an area, the anti-shrink back device further comprising a separator that extends from the band and divides the area into two separate areas.

11. The anti-shrink back device of claim 1, wherein the band is integrally formed with or coupled to a compression lug.

12. A system comprising:
an electrical conductor including an insulated segment surrounded by insulation and an uninsulated segment extending from the insulated segment, the uninsulated segment not surrounded by the insulation; and
an anti-shrink back device comprising a band mechanically tightened at least partially around the insulation in the insulated segment at an end of the insulation adjacent to the uninsulated segment to secure or inhibit shrink back of the end of the insulation longitudinally relative to the electrical conductor.

13. The system of claim 12, wherein at least one of:
the anti-shrink back device is electrically insulated from the electrical conductor;
the anti-shrink back device is not mechanically secured directly to the uninsulated segment of the electrical conductor; or
the anti-shrink back device is mechanically secured directly to the insulation exclusive of the electrical conductor.

14. The system of claim 12, wherein:
the electrical conductor further includes a second insulated segment surrounded by second insulation;
the second insulated segment is adjacent to the uninsulated segment and at an opposite end of the uninsulated segment from the insulated segment; and
the anti-shrink back device further comprises:
a second band mechanically tightened at least partially around the second insulation at an end of the second insulation adjacent to the uninsulated segment of the electrical conductor; and
a connector that couples the band and the second band together, the connector spanning a length of the uninsulated segment of the electrical conductor.

15. The system of claim 12, wherein the band is circular or semi-circular and defines a plurality of openings into which the insulation partially protrudes.

16. The system of claim 12, wherein the band is circular or semi-circular and the anti-shrink back device further comprises and at least one of:
one or more first protrusions that extend radially inward from the band; or
one or more second protrusions that extend radially outward from the band.

17. The system of claim 12, wherein:
the band at least partially encloses an area, the anti-shrink back device further including a separator that extends from the band and divides the area into separate first and second areas;
the separator and a first portion of the band that define the first area are mechanically tightened at least partially around the insulation in the insulated segment at the end of the insulation adjacent to the uninsulated segment of the electrical conductor;
the system further comprises a second electrical conductor that includes a second insulated segment surrounded by second insulation and a second uninsulated segment extending from the second insulated segment; and
the separator and a second portion of the band that define the second area are mechanically tightened at least partially around the second insulation in the second insulated segment at an end of the second insulation adjacent to the second uninsulated segment of the second electrical conductor.

18. The system of claim 12, further comprising a compression lug that electrically couples the uninsulated segment of the electrical conductor to a second uninsulated segment of a second electrical conductor, wherein:
the compression lug defines a first crimp channel within which the uninsulated segment of the electrical conductor is positioned, the first crimp channel at least partially crimped around the uninsulated segment of the electrical conductor;
the compression lug defines a second crimp channel within which the second uninsulated segment of the second electrical conductor is positioned, the second crimp channel at least partially crimped around the second uninsulated segment of the second electrical conductor;
the anti-shrink back device is integrally formed with or coupled to the compression lug;
the band of the anti-shrink back device defines a third crimp channel that extends from the first crimp channel; and
the end of the insulation adjacent to the uninsulated segment of the electrical conductor is positioned in the third crimp channel, the third crimp channel at least partially crimped around the end of the insulation adjacent to the uninsulated segment of the electrical conductor.

19. The system of claim 12, further comprising at least one of an undermold or an overmold that surrounds both the uninsulated segment of the electrical conductor and the anti-shrink back device.

20. An anti-shrink back device, comprising:
a band positionable on an end of insulation that surrounds an electrical conductor on an insulated segment of the electrical conductor, the end of the insulation in the insulated segment adjacent to an uninsulated segment of the electrical conductor;
wherein the band is mechanically tightenable on the end of the insulation to lock the insulation longitudinally in place with respect to the electrical conductor; and
wherein the band is not electrically coupled to the uninsulated segment of the electrical conductor.

21. A method, comprising:
stripping insulation from an end of a drop line to expose an end of a drop line conductor included in the drop line;
mechanically tightening a first band of a first anti-shrink back device around an end of the insulation of the drop line that is adjacent to the exposed end of the drop line conductor to inhibit movement of the end of the insulation of the drop line longitudinally relative to the drop line conductor;
stripping insulation from an intermediate segment of a feeder cable to expose an intermediate segment of a feeder cable conductor included in the feeder cable;
mechanically tightening a second band of a second anti-shrink back device around an end of the insulation of the feeder cable that is adjacent to the intermediate segment of the feeder cable conductor to inhibit movement of the end of the insulation of the feeder cable longitudinally relative to the feeder cable conductor;
electrically coupling the exposed end of the drop line conductor to the exposed intermediate segment of the feeder cable conductor; and
forming a mold structure that surrounds the first and second anti-shrink back devices and the electrically coupled exposed end and the exposed intermediate segment.

22. The method of claim 21, wherein mechanically tightening the first band comprises crimping the first band around the end of the insulation of the drop line.
